(19) United States
(12) Patent Application Publication
(10) Pub. No.: US 2004/0181817 A1
(43) Pub. Date: Sep. 16, 2004

(54) Media control system and method

(76) Inventor: Joel B. Larner, Fort Collins, CO (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/386,953

(22) Filed: Mar. 12, 2003

(51) Int. Cl. H04N 7/16

(52) U.S. Cl. 725/143; 725/153; 725/149; 725/147

(57) ABSTRACT

A media control system comprises a memory accessible by a processor and a content manager stored in the memory and adapted to receive media content from a media source. The content manager is further adapted to automatically identify, from the received media content, primary media content for directing to a primary media device and ancillary media content for directing to an ancillary media device.

### TECHNICAL FIELD OF THE INVENTION

The present invention relates generally to the field of communications and, more particularly, to a media control system and method.

### BACKGROUND OF THE INVENTION

There are many types of media devices currently available for presenting various types of media content to a user. For example, televisions, radios, computers, and a variety of portable or handheld electronic devices are available for presenting various types of audio and/or visual information to a user. However, each individual media device is generally limited as to the type of media content that may be presented to a user and the level of interactivity associated with the media device. For example, although a television may be used to present audio and/or visual media content to a user associated with a television broadcast, a television does not generally support interactive communication relating to the television broadcast. Additionally, for a user to interact or perform an action relating to the television broadcast, such as participating in a voting poll, the user must generally access another device designed to provide the particular interactive function, such as logging onto a computer to access a particular website.

### SUMMARY OF THE INVENTION

In accordance with one embodiment of the present invention, a media control system comprises a memory accessible by a processor and a content manager stored in the memory and adapted to receive media content from a media source. The content manager is further adapted to automatically identify, from the received media content, primary media content for directing to a primary media device and ancillary media content for directing to an ancillary media device.

In accordance with another embodiment of the present invention, a media control method comprises receiving media content from a media source and automatically identifying primary media content and ancillary media content from the received media content. The method also comprises directing the primary media content to a primary media device and directing the ancillary media content to an ancillary media device.

### BRIEF DESCRIPTION OF THE DRAWINGS

For a more complete understanding of the present invention and the advantages thereof, reference is now made to the following descriptions taken in connection with the accompanying drawings in which:

FIG. 1 is a diagram illustrating an embodiment of a media control system in accordance with the present invention; and

FIG. 2 is a flow chart illustrating an embodiment of a media control method in accordance with the present invention.

### DETAILED DESCRIPTION OF THE DRAWINGS

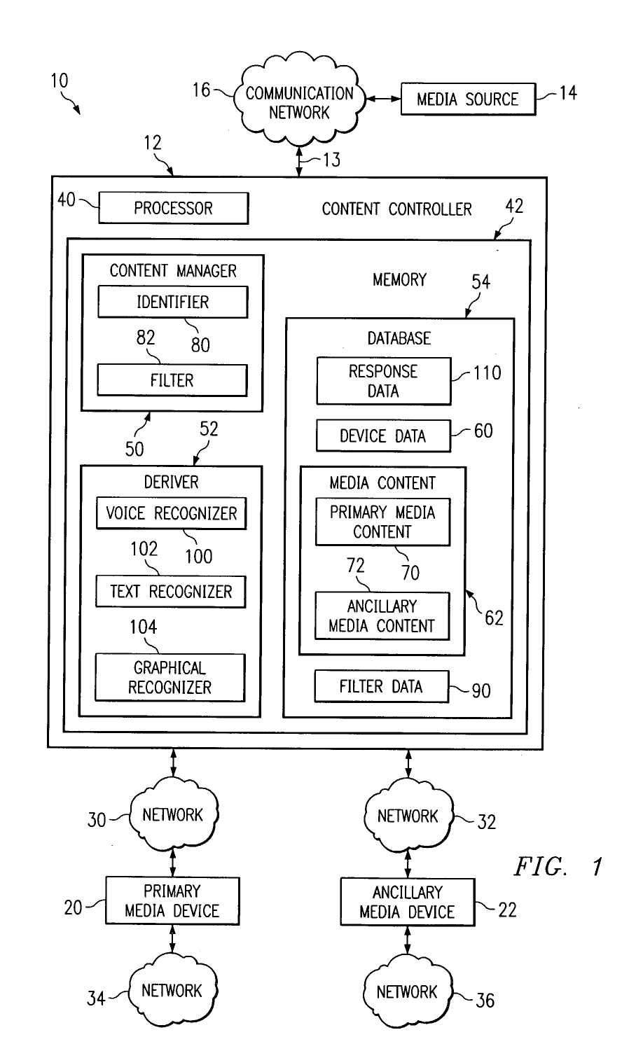

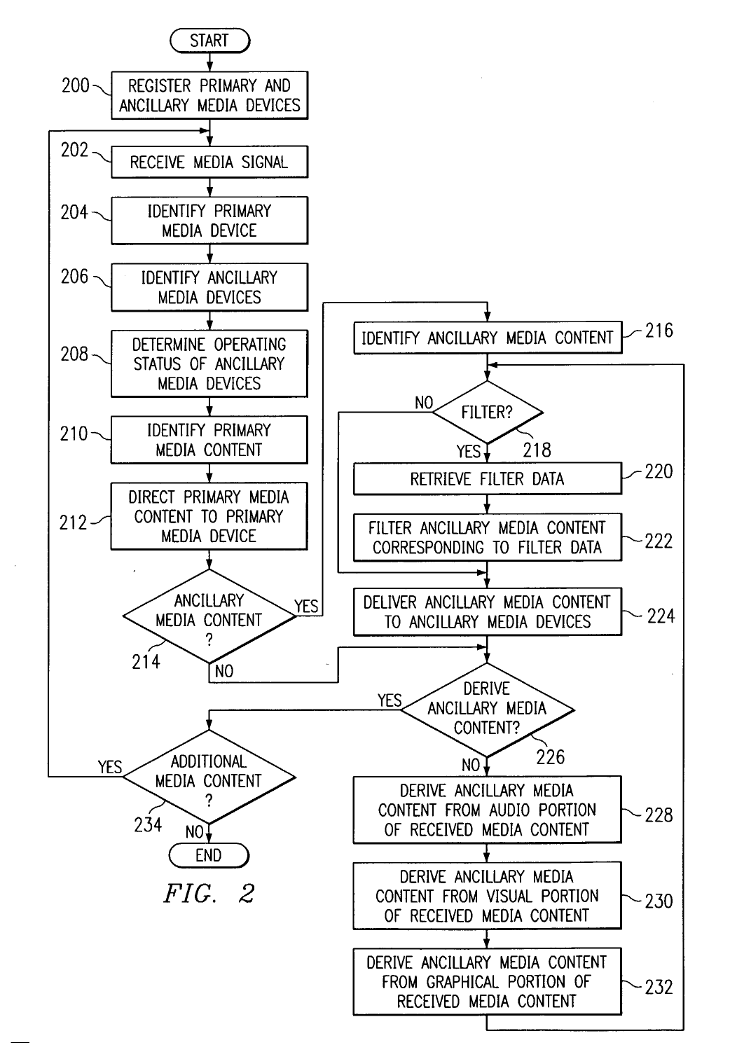

The preferred embodiments of the present invention and the advantages thereof are best understood by referring to FIGS. 1 and 2 of the drawings, like numerals being used for like and corresponding parts of the various drawings.

FIG. 1 is a diagram illustrating an embodiment of a media control system 10 in accordance with the present invention. Briefly, system 10 receives media content from at least one of a plurality of different media sources and distributes the media content to a plurality of media devices. In one embodiment of the present invention, the media content may comprise information corresponding to a plurality of media devices such that system 10 receives and distributes the media content to each corresponding media device. For example, a television broadcast type of media content may comprise information to be primarily directed to a television and ancillary information to be directed to a computer, amplifier, or other type of separate and distinct media device. Thus, in this example, system 10 separates or derives the various types of media content from a particular media signal and delivers the media content to each corresponding device. System 10 also identifies the form of the various types of media content for instructing the corresponding devices concerning the manner of displaying or otherwise using the delivered media content. In another embodiment of the present invention, system 10 may derive information to be delivered to various media devices from the received media content. For example, in a television broadcast type of media content, system 10 directs the primary media content to a television and derives from the received media content ancillary information for delivery to a different media device. Thus, system 10 accommodates the use of multiple media devices to present various types of media content to a user, thereby providing the user with the ability to interact with multiple media devices independently or concurrently corresponding to a particular media content such as a television or radio broadcast.

In the embodiment illustrated in FIG. 1, system 10 comprises a content controller 12 for receiving audio and/or visual information in the form of a media signal 13 from at least one media source 14 via a communication network 16. Media source 14 may comprise any source for providing audio and/or visual information such as, but not limited to, a television signal broadcasting source, an audio or radio broadcasting signal source, a server, a video cassette recorder (VCR), a digital video disk (DVD) player, or any other type of device for transmitting or otherwise delivering audio and/or visual information. Communication network 16 may comprise any type of wired or wireless communication network for communicating the audio and/or visual information such as, but not limited to, the Internet, an intranet, antenna, satellite, infrared or other type of optical communication system, a serial or parallel bus, or other types of communication medium.

As illustrated in FIG. 1, system 10 also comprises a primary media device 20 and an ancillary media device 22. Media devices 20 and 22 comprise any type of device for receiving, storing, recording, transmitting, displaying, and/or otherwise generating an output of visual and/or audio information. For example, devices 20 and 22 may each comprise a television, a radio, an amplifier, a receiver, a tuner, a computer, a portable media device, a VCR, a DVD player, or other type of device associated with receiving, storing, recording, displaying, and/or otherwise generating an output of audio and/or visual information. As used herein, the terms “primary” and “ancillary” are used to identify a particular media device and/or a particular type of media content. For example, if the media signal 13 received from media source 14 comprises a television broadcast, the television broadcast media signal 13 may comprise the “primary” media content and the “primary” media device 20 may comprise a television or other device for receiving and/or displaying the television broadcast media signal 13. An “ancillary” media device 22 comprises a separate and distinct media device than the primary media device 20 for providing or displaying media information. Thus, if the “primary” media device 20 comprises a television for receiving television broadcast media signals 13, the “ancillary” media device 22 may comprise a computer, radio, or other type of media instrument. Correspondingly, the media information delivered to ancillary media device 22 may be identified as “ancillary” media content. Each media device 20 or 22 may comprise associated output or peripheral instruments or devices, such as a speaker, printer, or other type of output instrument, that together form a single media device 20 or 22. For example, a computer system primary media device 20 may comprise a desktop chassis or housing containing processor, memory, and/or drive devices, a monitor, a printer, a keyboard, and a mouse, such that, together, the various components form the computer system primary media device 20. Thus, media devices 20 and 22 comprise separate and distinct devices such that controller 20 is adapted to receive a single media signal 13 and direct primary and ancillary media content to separate and distinct devices.

Controller 12 is coupled to primary media device 20 and ancillary media device 22 via communication networks 30 and 32, respectively. Communication networks 30 and 32 may comprise any type of wired or wireless communication medium for communicating information between controller 12 and devices 20 and 22, respectively. Communication networks 30 and 32 may comprise discrete communication mediums or may comprise the same communication medium. For example, if media devices 20 and 22 each comprise a computer, networks 30 and 32 may comprise the same communication medium for communicating information between devices 20 and 22 with controller 12. Additionally, in FIG. 1, controller 12 is illustrated as a discrete component disposed separate from media devices 20 and/or 22; however, it should be understood that controller 12 may also be configured integrally with media devices 20 and/or 22. For example, if primary media device 20 comprises a television, controller 12 may be configured as an integral component of the television such that a separate device disposed outside or separate from the television is not required.

In FIG. 1, a single primary media device 20 and a single ancillary media device 22 are illustrated; however, it should be understood that a plurality of primary and ancillary media devices 20, 22 may be communicatively coupled to controller 12. Primary media device 20 and ancillary media device 22 may each also be coupled to a discrete communication network 34 and 36, respectively, for communicating information from devices 20 and 22 independently of controller 12. For example, as will be described in greater detail below, primary media device 20 may comprise a television and ancillary media device 22 may comprise a computer. Thus, media source 14 may comprise a source of a television broadcast such that the primary destination for the audio and/or visual information is a television primary media device 20. Thus, if ancillary media device 22 is a computer, communication network 36 may provide a communication medium for the computer ancillary media device 22 to communicate information to a different location independent of controller 12 corresponding to audio and/or visual information received from controller 12 by media device 22.

In the embodiment illustrated in FIG. 1, content controller 12 comprises a processor 40 coupled to a memory 42. The present invention also encompasses computer software that may be stored in memory 42 as to be accessible by processor 40. For example, in the illustrated embodiment, memory 42 comprises a content manager 50 and a deriver 52. Content manager 50 and deriver 52 may comprise software, hardware, or a combination of software and hardware. Additionally, in the illustrated embodiment, content manager 50 and deriver 52 are illustrated as being stored in memory 42 so that they may be accessible by processor 40. However, it should be understood that content manager 50 and deriver 52 may be otherwise stored, even remotely, as to be accessible by processor 40.

In the embodiment illustrated in FIG. 1, memory 42 also comprises a database 54 for storing information related to the audio and/or visual information received and/or delivered by controller 12. For example, in the illustrated embodiment, database 54 comprises device data 60 and media content 62. Device data 60 comprises information associated with the types of media devices 20 and 22 coupled to controller 12. For example, content controller 12 may be configured to perform an enumeration process to determine devices 20 and 22 for receiving information from controller 12. Alternatively, a user of system 10 may register devices 20 and 22 with controller 12 such that controller 12 may access device data 60 to determine available devices 20 and 22 for receiving audio and/or visual information. Media content 62 comprises the media information, such as audio and/or visual information, received from media source 14. In the illustrated embodiment, media content 62 comprises primary media content 70 and ancillary media content 72. Primary media content 70 comprises audio and/or visual information received from media source 14 to be directed to a primary media device 20. For example, if media source 14 comprises a source of a television broadcast signal, primary media device 20 may comprise a television such that primary media content 70 represents the audio and/or visual information received from media source 14 to be transmitted to and displayed by a television primary media device 20. Ancillary media content 72 comprises audio and/or visual information, uniform resource locators (URLs), interactive features, or other types of information or data to be delivered to at least one ancillary media device 22. As will be described below, ancillary media content 72 may be received from media source 14 so as to be specially designated for ancillary media device 22 or may require derivation from the received primary media content 70. In FIG. 1, media content 62 is illustrated as being stored in database 54; however, it should be understood that media content 62 may also be received from media source 14 and delivered to media devices 20 and 22 in real-time, thereby resulting in no storage or temporal storage of media content 62 in memory 42.

As illustrated in FIG. 1, content manager 50 comprises an identifier 80 and a filter 82. Identifier 80 comprises software, hardware, or a combination of software and hardware, for identifying the different types of media content 62 received from media source 14. For example, media content 62 may comprise information corresponding to various types of media devices 20 and 22 such that identifier 80 automatically identifies the various types of media content 62 and directs the various types of media content 62 to corresponding media devices 20 and 22. The different types of media content 62 may be delivered from media source 14 via separate spectrums or channels of a particular communication medium or may be otherwise combined or transmitted such that identifier 80 identifies and/or separates the various types of media content 62 so that each type of media content 62 may be directed to a corresponding media device 20 and/or 22.

Filter 82 comprises software, hardware, or a combination of software and hardware, for filtering ancillary media content 72 directed to ancillary media device(s) 22. For example, a user of system 10 may identify various types of information that the user desires to direct to a particular ancillary media device 22 or that the user desires to disregard such that particular types of ancillary media content 72 are not directed to ancillary media device(s) 22. Thus, a user of system 10 may configure controller 20 to disregard certain types of information identified or derived as ancillary media content 72 such that the identified types of information are not directed or transmitted to an ancillary media device 22. For example, controller 20 may identify or derive a website address from a television broadcast media signal 13 directed toward a television primary media device 20 as ancillary media content 72 to be directed toward a computer ancillary media device 22. Filter 82 may be used to prevent controller 20 from directing the website address to the computer ancillary media device 22. The information used by filter 82 to filter ancillary media content 72 may be stored in database 54 as filter data 90.

As described above, controller 12 may also be configured to derive the ancillary media content 72 from the media content 62 received from media source 14. For example, in the illustrated embodiment, deriver 52 comprises a voice recognizer 100, a text recognizer 102, and a graphical recognizer 104. Voice recognizer 100, text recognizer 102, and graphical recognizer 104 may each comprise software, hardware, or a combination of software and hardware, for deriving ancillary media content 72 from the information received from media source 14. For example, voice recognizer 100 may comprise voice recognition applications or software for identifying particular types of media information from audio media content 62. Thus, in operation, if audio information is received from media source 14, voice recognizer 100 may be configured to automatically detect or identify ancillary media content 72 from the received audio information. For example, if media source 14 comprises an audio broadcast, voice recognizer 100 may automatically detect and identify types of information from the audio broadcast information, such as, but not limited to, a website address, a television channel, station call letters, or other types of information as ancillary media content 72. Thus, in this example, primary media device 20 may comprise a radio, amplifier, tuner, receiver, or other type of device for receiving audio media content 62 from media source 14, and the ancillary media device 22 may comprise a television, computer, or other separate device for receiving the ancillary media content 72. Voice recognizer 100 may utilize voice recognition software or other means to evaluate the received audio information and automatically identify ancillary media content 72 from the received audio media content 62. Controller 12 then directs the identified ancillary media content 72 to corresponding ancillary media devices 22, such as a computer, a television, or other corresponding media device.

In operation, text recognizer 102 evaluates the received visual information from media source 14 and derives ancillary media content 72. For example, in the case of a television broadcast signal from media source 14, text recognizer 102 may evaluate the visual information and automatically identify textual information as ancillary content 72. Thus, in this example, primary media device 20 may comprise a television such that text recognizer 102 may automatically identify a website address or other textual information from the visual received media content 62 as ancillary media content 72. Controller 12 may then direct the identified ancillary media content 72 to corresponding ancillary media devices 22. Thus, in this example, a website address identified by text recognizer 102 may be automatically directed to a computer ancillary media device 22 such that the computer may be instructed to automatically open a browser and initiate access to the identified web page address. Graphical recognizer 104 analyzes the graphical content received from media source 14 and derives ancillary media content 72. For example, graphical recognizer 104 may evaluate graphical or visual information to identify the type of visual information, such as, but not limited to, a photograph or still image, a chart or a graph, such that controller 12 may direct the identified content to an ancillary media device 22, such as, but not limited to, directing data corresponding to a photograph or still image to an electronic photoframe.

Media devices 20 and/or 22 may also comprise interactive capabilities such that a user may input information to media devices 20 and/or 22 to accommodate communication with controller 12 and/or communication with another system via devices 20 and/or 22. For example, ancillary media device 22 may comprise a computer such that a user may input various information in response to received ancillary media content 72. Thus, in this example, the computer ancillary media device 22 may communicate via network 36 to open a web page address or other type of ancillary media content 72 received from controller 12. Alternatively, ancillary media device 22 may also communicate information received from a user of ancillary media device 22 to controller 12. For example, if ancillary media device 22 comprises a computer and ancillary media content 72 comprises information associated with a web page address, access to the particular web page may be acquired via communication network 16. Thus, in this example, controller 12 may be configured to provide interactive communications for a variety of types of media content 62. The information received by controller 12 from media devices 20 and/or 22 may be stored in database 54 as response data 110.

Response data 110 may also be used to modify primary media content 70 received by primary media device 20 and/or ancillary media content 72 received by ancillary media device 22. For example, response data 110 may be received by controller 12 from ancillary media device 22 indicating a requested change in content of primary media content 70 delivered to primary media device 20 and/or a modification of filter data 90. Thus, devices 20 and/or 22 may be used to interactively modify media content 62 received by media devices 20 and/or 22.

Thus, in operation, a user may view, listen, or otherwise experience primary media content 70 from primary media device 20 while also viewing, listening or otherwise using ancillary media content 72 delivered to ancillary media device(s) 22. For example, while watching a television broadcast on primary media device 20, a reference to a web site contained within the broadcast or derived from the broadcast may be directed to a computer ancillary media device 22 so that the user may interact with the web site while the television broadcast remains uninterrupted. Additionally, while watching a DVD movie on primary media device 20, additional features on the DVD and/or derived from the DVD may be delivered to ancillary media device(s) 22 to accommodate, for example, an e-commerce transaction relating to the DVD or its content. Further, for example, while listening to an Internet or radio audio broadcast on primary media device 20, ancillary media content may be directed to ancillary media device(s) 22 so that the user may obtain additional information about a recording artist, purchase a recording by the artist, view a music video of a recording, or otherwise perform another activity using ancillary media device(s) 22 while the audio broadcast remains uninterrupted. Thus, system 10 enhances the media enjoyment experience by the user by providing the user with additional forms of media content related to the primary media experience in a practically seamless and uninterrupted manner to the primary media experience.

FIG. 2 is a flowchart illustrating an embodiment of a media control method in accordance with the present invention. The method begins at block 200, where controller 12 registers primary media device 20 and ancillary media devices 22 for receiving media content 62. At block 202, controller 12 receives media signal 13 from a media source 14. At block 204, controller 12 identifies primary media device 20 corresponding to the type of media content 62 received from media source 14. For example, controller 12 may evaluate the type of media content 62 received, the media source 14, or other information associated with indicating a particular primary media device 20 for receiving media content 62. At block 206, controller 12 also identifies ancillary media devices 22 from device data 60. For example, controller 12 may access device data 60 to determine available ancillary media devices 22 for receiving media content 62. At block 208, controller 12 determines an operating status of each of ancillary media devices 22 identified in block 206. For example, controller 12 may initiate an enumeration process or otherwise poll or request response information from ancillary media devices 22 to determine an operating status of corresponding ancillary media devices 22 such that controller 12 identifies the operating ancillary media devices 22 for receiving ancillary media content 72.

At block 210, controller 12 identifies primary media content 70 from media content 62 received from media source 14. At block 212, controller 12 directs primary media content 70 to the corresponding primary media device 20. At decision block 214, a determination is made whether media content 62 received from media source 14 contains ancillary media content 72. If the received media content 62 does not contain ancillary media content 72, the method proceeds to block 226. If the received media content 62 does contain ancillary media content 72, the method proceeds from block 214 to block 216, where controller 12 identifies the ancillary media content 72.

At decision block 218, a determination is made whether ancillary media content 72 is to be filtered prior to delivering ancillary media content 72 to ancillary media device 22. If the ancillary media content 72 will not be filtered, the method proceeds to block 224. If the ancillary media content 72 does require filtering, the method proceeds from block 218 to block 220, where content manager 50 retrieves filter data 90 from database 54. At block 222, filter 82 applies filter data 90 to the ancillary media content 72. At block 224, controller 12 delivers the filtered ancillary media content 72 to ancillary media device 22 or, alternatively, disregards the ancillary media content 72 as directed by filter 82.

At decision block 226, a determination is made whether to derive ancillary media content 72 from the media content 62 received from media source 14. If ancillary media content 72 is to be derived from the media content 62 received from media source 14, the method proceeds to block 228, where deriver 52 derives ancillary media content 72 from an audio portion of media content 62 received from media source 14. At block 230, deriver 52 drives ancillary media content 72 from a visual portion of media content 62 received from media source 14. At block 232, deriver 52 drives ancillary media content 72 from a graphical portion of media content 62 received from media source 14. The method then returns to block 218. If ancillary media content 72 will not be derived from media content 62 received from media source 14 at block 226, the method proceeds from block 226 to decision block 234, where a determination is made whether additional media content 62 is received from media source 14. If additional media content 62 is received from media source 14, the method returns to block 202.

Thus, the present invention provides a media control system 10 for identifying and directing a variety of types of media content 62 to each of a plurality of separate media devices 20, 22. System 10 may be configured such that media devices 20 and/or 22 provide interactive capabilities to accommodate communication between media devices 20 and/or 22 and other systems. Therefore, it should be understood that in the described method, certain blocks may be omitted, combined, or accomplished in a sequence different than depicted in FIG. 2. Also, it should be understood that the method depicted may be altered to encompass any of the other features or aspects of the invention as described elsewhere in the specification.

What is claimed is:

1. A media control system, comprising:
a memory accessible by a processor; and
a content manager stored in the memory and adapted to receive media content from a media source, the content manager further adapted to automatically identify, from the received media content, primary media content for directing to a primary media device and ancillary media content for directing to an ancillary media device.

2. The system of claim 1, wherein the received media content is selected from the group consisting of television broadcast media content, audio broadcast media content, Internet media content, and recorded media content.

3. The system of claim 1, further comprising a deriver stored in the memory and adapted to derive the ancillary media content from the received media content.

4. The system of claim 1, wherein the primary media device is selected from the group consisting of a television, an audio receiver, an amplifier, a computer, a video player, and a portable media device.

5. The system of claim 1, wherein the ancillary media device is selected from the group consisting of a television, an audio receiver, an amplifier, a computer, a video player and a portable media device.

6. The system of claim 1, wherein the content manager is adapted to automatically determine an operating status of the ancillary media device.

7. The system of claim 1, wherein the content manager is adapted to filter the ancillary media content before delivering the ancillary media content to the ancillary media device.

8. The system of claim 1, further comprising a voice recognizer adapted to derive the ancillary media content from an audio portion of the received media content.

9. The system of claim 1, further comprising a text recognizer adapted to derive the ancillary media content from a visual portion of the received media content.

10. The system of claim 1, wherein the content manager is adapted to receive response data from the ancillary media device corresponding to the ancillary media content.

11. The system of claim 1, wherein the content manager is adapted to communicate response data corresponding to the ancillary media content from the ancillary media device to the media source.

12. The system of claim 1, further comprising a graphical recognizer adapted to derive the ancillary media content from a visual portion of the received media content.

13. A media control method, comprising:
receiving media content from a media source;
automatically identifying primary media content and ancillary media content from the received media content;
directing the primary media content to a primary media device; and
directing the ancillary media content to an ancillary media device.

14. The method of claim 13, further comprising deriving the ancillary media content from the received media content.

15. The method of claim 13, further comprising filtering the ancillary media content before delivering the ancillary media content to the ancillary media device.

16. The method of claim 13, further comprising deriving the ancillary media content from an audio portion of the received media content.

17. The method of claim 13, further comprising deriving the ancillary media content from a visual portion of the received media content.

18. The method of claim 13, further comprising receiving response data from the ancillary media device corresponding to the ancillary media content.

19. The method of claim 13, further comprising automatically determining an operating status of the ancillary media device.

20. The method of claim 13, further comprising communicating response data received from the ancillary media device corresponding to the ancillary media content to the media source.

21. A media control system, comprising:
means for receiving media content from a media source; and
means for automatically identifying, from the received media content, primary media content for directing to a primary media device and ancillary media content for directing to an ancillary media device.

22. The system of claim 21, further comprising means for deriving the ancillary media content from the received media content.

23. The system of claim 21, further comprising means for filtering the ancillary media content before directing the ancillary media content to the ancillary media device.

24. The system of claim 21, further comprising means for receiving response data from the ancillary media device corresponding to the ancillary media content.

25. The system of claim 21, further comprising means for deriving the ancillary content from an audio portion of the received media content.

26. The system of claim 21, further comprising means for deriving the ancillary content from a visual portion of the received media content.

27. The system of claim 21, further comprising means for communicating response data received from the ancillary media device corresponding to the ancillary media content to the media source.

28. The system of claim 21, further comprising means for automatically determining an operating status of the ancillary media device.
